(19) United States
(12) Patent Application Publication
(10) Pub. No.: US 2013/0161295 A1
(43) Pub. Date: Jun. 27, 2013

(54) Laser Cavity Exhibiting Low Noise

(71) Applicant: Keisuke Tominaga, Tokyo (JP)

(72) Inventor: Keisuke Tominaga, Tokyo (JP)

(73) Assignee: OFS FITEL, LLC, Norcross, GA (US)

(21) Appl. No.: 13/819,110

(22) PCT Filed: Sep. 2, 2011
(86) PCT No.: PCT/US11/50364

§ 371 Date: Feb. 26, 2013

Related U.S. Application Data
(60) Provisional application No. 61/379,587, filed on Sep. 2, 2010.

(51) Int. Cl. H01S 3/067; B23K 26/38; B23K 26/20; B23K 26/00

(52) U.S. Cl. CPC H01S 3/0675; B23K 26/00; B23K 26/38; B23K 26/20; B23K 26/381
USPC 219/85.13; 372/6; 219/121.85; 219/121.72; 219/121.64; 219/121.71

(57) ABSTRACT

Inventive single cavities for use in a high power fiber laser systems are described that include a high reflective grating, a gain fiber, an output coupler having a bandwidth in the range of 1 nm to 2 nm; and an output fiber connected to the single cavity that supplies power from the single cavity. The single cavity can be used in a wide variety of applications, including welding, cutting, brazing or drilling a material, or to seed a downstream amplifier.

### CROSS-REFERENCE TO RELATED APPLICATIONS

This application claims the benefit of priority under 35 U.S.C. §119(e) to U.S. Provisional Application Ser. No. 61/379,587, filed on Sep. 2, 2010, the disclosure of which is incorporated herein by reference in its entirety.

### TECHNICAL FIELD

This application relates to a laser cavity having a reflective grating and an output coupler with a bandwidth in ranges from 1 nm to 2 nm.

### BACKGROUND

Laser systems including fiber amplifiers are commonly used in many applications, including telecommunications applications and high-power military and industrial fiber optic applications. In operation, the propagating optical signal from a laser source is introduced in the core region of a section of optical fiber and is amplified through the use of an optical “pump” signal. The pump signal is of a predetermined wavelength that will interact with particular dopants included in the core region of the fiber amplifier (typically rare earth materials, such as erbium, ytterbium, or the like) to amplify the propagating optical signal.

The signal output of a high power fiber laser can be limited by non-linear effects. These non-linear effects include Stimulated Raman scattering (SRS), Stimulated Brillion Scatter (SBS) and others. SRS is a particular problem for continuous wave high power lasers. When a signal power of a high power fiber laser is increased beyond a threshold power level, typically a few hundred watts and higher in conventional optical fiber, the energy of the signal is transferred to a higher wavelength. At this point, it is difficult to further increase the signal output power.

Conventional wisdom is that the threshold for the onset of nonlinear effects is governed by the average optical intensity in a continuous wave laser or by the peak intensity in a pulsed laser. To reduce SRS, a gain fiber having a larger core diameter can be used. This reduces the optical intensity for a given average power and can increase the threshold of non-linear effects. Additionally, using a shorter length of the gain fiber can reduce the growth of the non-linear signal. These approaches, however, reduce efficiency for a high power fiber laser and often degrade the quality of the signal mode.

Accordingly, new and improved methods and apparatus for providing a high power fiber laser that reduces the effects of SRS on the power output provided are needed.

### SUMMARY

A first embodiment of the invention pertains to a single laser cavity for use in a high power fiber laser system, comprising: a high reflective grating; a gain fiber; an output coupler, the output coupler having a bandwidth in the range of 1 nm to 2 nm; and an output fiber connected to the single cavity laser that supplies power from the single cavity. In a second embodiment, the laser can further comprise a pump diode. In more specific embodiments, the bandwidth of the output coupler is in the range of 1.2 nm to 2 nm, more specifically, in the range of 1.4 to 2 nm, and even more specifically in the range of 1.6 to 2 nm.

In any of the embodiments described above, the high reflective grating and the output grating and the output coupler may comprise fiber Bragg gratings. In any of the embodiments above, the output fiber may be a multimode fiber. Any of the embodiments above can include a pump source to introduce pump light into the gain fiber, the pump source comprising a plurality of pump diodes connected to the single cavity through a pump combiner. The wavelengths of the pump diodes can be in the range of 900 nm to 990 nm.

According to one or more embodiments, the number of longitudinal modes in the laser cavity is increased compared to a system that uses an output coupler having a bandwidth lower than 1 nm. In certain embodiments, nonlinear effects caused by SRS are reduced compared to a single cavity laser that uses an output coupler having a lower bandwidth. In specific embodiments, the slope efficiency of the cavity is in the range of 65% to 70%.

In any of the embodiments described above, the gain fiber can be a rare earth doped fiber. The gain fiber can have any suitable length, and in specific embodiments, has a length of 25 meters or greater. In specific embodiments, the gain fiber has a mode field diameter (MFD) of less than 12 microns.

In specific embodiments, the pump source provides a power such that the output power of the cavity exceeds 250 Watts. In other specific embodiments, the pump source has a pump wavelength in the range of 900 to 1000 nm.

An aspect of the invention pertains to a fiber laser system comprising the single cavity laser according to any of the embodiments described above, and further comprising a amplifier. The amplifier can be a downstream amplifier seeded by the single cavity laser.

Another aspect of the invention pertains to a device for welding, cutting, brazing or drilling a material comprising the single cavity laser of any of the embodiments described above.

Still another aspect of the invention pertains to a method of reducing Stimulated Raman Scattering (SRS) in of a high power single cavity fiber laser having an output power exceeding 250 Watts comprising the steps of: coupling a fiber amplifier to an output coupler having a bandwidth in the range of 1 nm to 2 nm such that the number of longitudinal modes in the laser cavity are increased, thereby reducing the SRS of the laser compared to a single cavity fiber laser having a bandwidth below 1 nm.

Yet another aspect of the invention pertains to a method of treating an object, comprising: operating a single cavity laser having a high reflective grating, a gain fiber, an output coupler having a bandwidth in the range of 1 nm to 2 nm and an output fiber connected to the single cavity laser to supply at least 250 Watts of power from the single cavity laser; and applying the at least 250 Watts of power from the single cavity laser to the object. In one or more embodiments according to this aspect, the object is cut, welded, brazed, and/or drilled by the single cavity laser.

### DESCRIPTION OF THE DRAWINGS

FIG. 1 illustrates a high power continuous wave laser in accordance with one aspect of the present invention;

FIG. 2 illustrates a time trace of the normalized voltage output from a high power laser system that uses an output coupler having a narrow bandwidth;

FIG. 3 illustrates the output signal spectrum from the cavity of a high power laser system that uses an output coupler having a narrow bandwidth;

FIG. 4 illustrates a time trace of the normalized voltage output from a high power laser system that uses an output coupler having a wide bandwidth in accordance with an aspect of the present invention;

FIG. 5 illustrates the output signal spectrum from the cavity of a high power laser system that uses any output coupler having a wide bandwidth;

FIG. 6 illustrates the output signal spectrum from the cavity of a high power laser system that uses any output coupler having various bandwidths; and

FIG. 7 illustrates a transmission spectrum for 0.6 nm and 1.5 nm output couplers.

### DETAILED DESCRIPTION

Before describing several exemplary embodiments of the invention, it is to be understood that the invention is not limited to the details of construction or process steps set forth in the following description. The invention is capable of other embodiments and of being practiced or being carried out in various ways.

Embodiments of the invention pertain to a single laser cavity for use in a high power fiber laser system, comprising, for example, a high reflective grating; a gain fiber; an output coupler having a bandwidth between 1 nm and 2 nm; and an output fiber connected to the single cavity that supplies power from the single cavity.

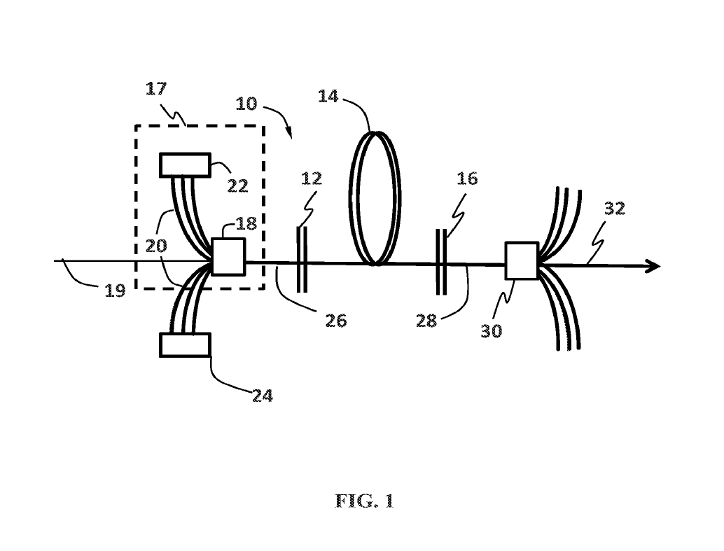

Referring now to FIG. 1, an example of a single laser cavity 10 is shown. The single cavity 10 comprises a reflective grating 12, a gain fiber 14 and an output coupler 16 having a bandwidth in the range of 1 nm to 2 nm. The reflective grating can be a high reflective grating. The single laser cavity 10 shown in FIG. 1 includes a pump source 17 including a pump combiner 18. As the skilled artisan will appreciate, the pump source can comprise a variety of pump sources. As shown in FIG. 1, pump source 17 comprises pump combiner 18, pump diode 22 and pump diode 24 in communication with a plurality of pump port fibers 20 and may comprise a monitor port fiber 19. The output of the pump combiner 18 includes an output port fiber 26 coupled to the high reflective grating 12. The output coupler 16 is coupled to output fiber 28. The laser cavity 10 shown in FIG. 1 may further include a second pump combiner 30 coupled to a second output fiber 32.

As used herein, “high power” with respect to a fiber laser system refers to powers equal to and exceeding 250 W, equal to and exceeding 300 W, equal to and exceeding 400 W and equal to and exceeding 1000 W. The high reflective grating according to one or more embodiments has a bandwidth exceeding 1.1 nm, for example in the range of 1.1 nm to 3 nm. According to one or more embodiment, the output coupler has a bandwidth in the range of 1 nm to 2 nm, and in specific embodiments, in the range of 1.2 nm to 2 nm, in the range of 1.4 to 2 nm, in the range of 1.6 to 2 nm and in the range of 1.8 to 2 nm. In specific embodiments, the output coupler and the high reflective grating comprise fiber Bragg gratings. To form the inventive laser cavity, the wavelength regions of the high reflector and output coupler should overlap.

The gain fiber according to one or more embodiments comprises a fiber amplifier, for example, a rare earth doped fiber amplifier doped with erbium, Yb, or other rare earth elements and combinations thereof. In specific embodiments, the length of the fiber amplifier exceeds 25 m. As noted above, it was previously believed that shorter lengths of the fiber amplifier were required to reduce nonlinear effects such as SRS. According to embodiments of the present invention, longer gain fiber lengths are possible. The use of a longer gain fiber length tends to reduce residual pump light. According to one or more embodiments, the gain fiber is essentially single-mode at the signal wavelength and as such typically has a mode field diameter of less than about 12 microns. In specific embodiments, the gain fiber comprises a Yb doped fiber having a length of 25 meters, and a core absorption of about 200 dB/meter at 915 nm.

In a more specific embodiment of the invention, the single laser cavity further comprises a pump source to introduce pump light into the gain fiber. The pump source comprises a plurality of pump diodes connected to the single cavity through a pump combiner. The pump combiner can comprise a number of pump inputs, 19 forward pump inputs being an exemplary number, and an output port fiber connected to the high reflective grating. The pump power source can comprise a plurality of pump diodes for example a plurality of pump diodes individually having a power in the range of 10 W to 100 W connected to the pump inputs. In a specific embodiment, the combiner includes a plurality of pump port fibers. In a more specific embodiment the pump port fibers can be acrylate coated fibers. In a specific embodiment, the wavelength of the pump diode is in the range of 900 nm to 1000 nm. Exemplary wavelengths include 915 nm, 940 nm and 975 nm. It will be understood that the specific embodiments described immediately above are exemplary embodiments only, and numerous variations of each of the parameters of the individual components can be varied in accordance with the scope of the present invention.

### Testing of Single Cavity Lasers

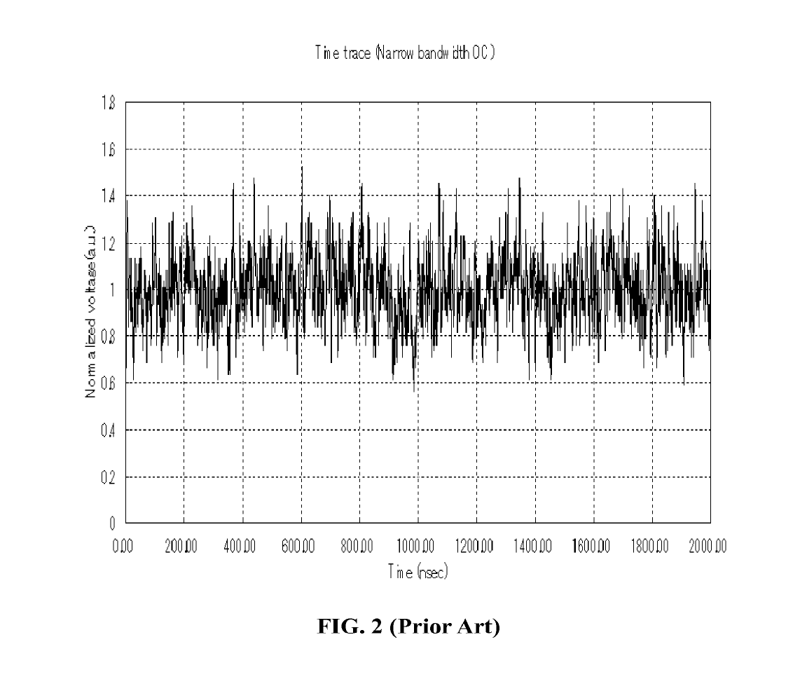

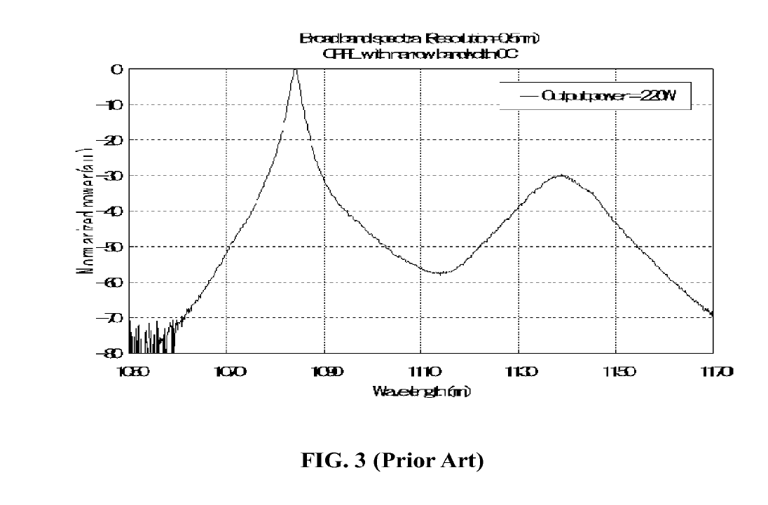

It was determined that noise in a single laser cavity with a narrow bandwidth output coupler leads to higher SRS as shown in FIGS. 2 and 3. FIG. 2 shows a time trace of the normalized voltage output from a high power laser system that uses an output coupler having a narrow bandwidth. FIG. 3 illustrates the spectra of the cavity in the high power laser system that uses an output coupler having a narrow bandwidth. A fiber laser with an average output signal power of 220 W was constructed with a narrow bandwidth (0.1 nm) output coupler. Noise was measured using an optical detector and an oscilloscope. The output wavelength spectrum in FIG. 3 shows significant growth of SRS around 1140 nm, which is surprising given the relatively low average power and the signal modefield diameter in the gain fiber. This behavior indicates that the nonlinear threshold in a laser is governed by the peak intensity of the noise spikes and not by the average optical intensity. Accordingly, we have determined that the nonlinear threshold can be increased by using a better cavity design to reduce the noise of the laser. It was found that the noise is related to the number of longitudinal modes in the laser cavity. For reducing noise in the laser cavity, a wider bandwidth Output Coupler (OC grating) was employed as described herein. When a wider bandwidth OC is used, the number of longitudinal modes is increased. The output coupler can be a grating or other form of output coupler that utilizes the bandwidths specified herein.

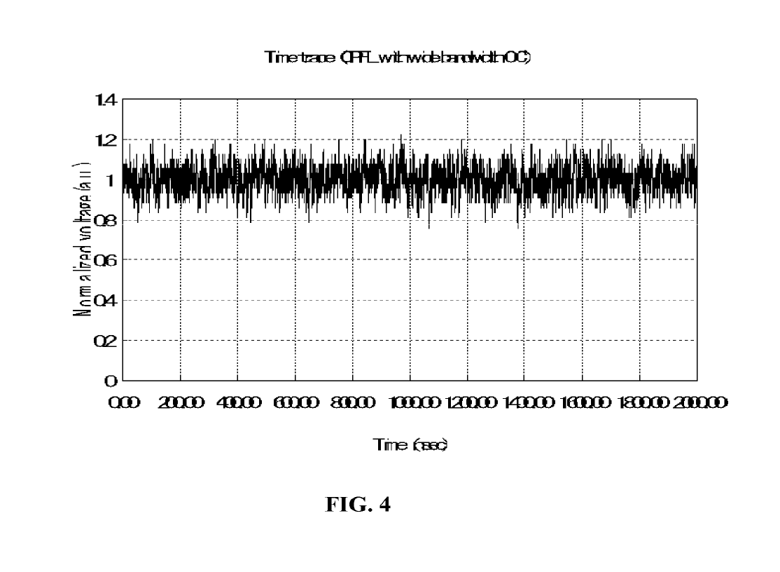

Referring now to FIG. 4, a time trace is shown of the normalized voltage output from a high power laser system, using the cavity in accordance with an aspect of the present invention, that uses an output coupler having a bandwidth wider than that used to acquire the data shown in FIG. 2. Comparing FIG. 4 and FIG. 2, it is seen the wider bandwidth output coupler greatly reduces the noise in the cavity.

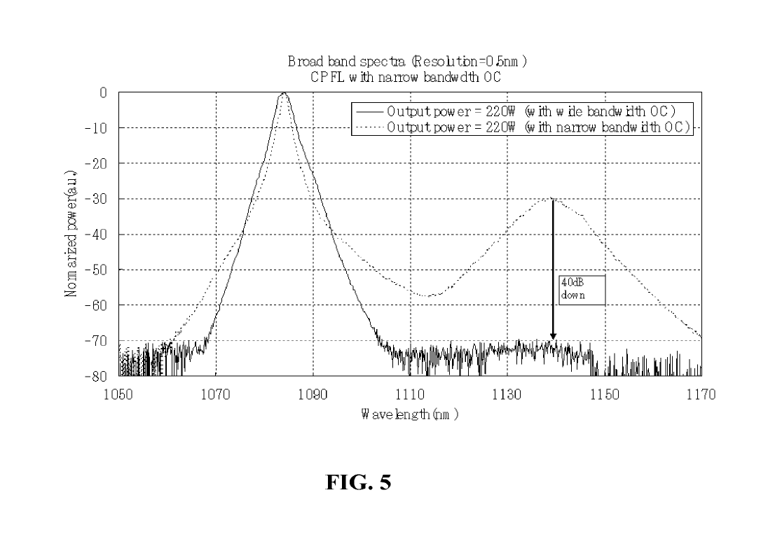

FIG. 5 illustrates the spectrum of the inventive cavity in the high power laser system that uses an output coupler having a wide bandwidth along with the data from FIG. 3. It is seen the wider bandwidth output coupler greatly reduces the SRS by 40 dB. This means that a cavity with the wider bandwidth output coupler can significantly reduce the SRS level. While the data in FIGS. 4 and 5 was generated using a output coupler having a bandwidth of 0.6 nm, the concept of the high bandwidth output coupler can be extended for high power fiber lasers such that the bandwidth is in the range of 1 nm to 2 nm. It is expected that SRS of higher power fiber laser such as those exceeding 250 W would be reduced using the 1-2 nm bandwidth OC.

Thus, it can be seen that the numbers of longitudinal modes in a single cavity laser depends on the bandwidth for the output coupler. A cavity with a wider bandwidth output coupler has a greater number of longitudinal modes. It has been determined that longitudinal modes relate to the noise in a cavity, and if the longitudinal modes in a cavity are increased, the noise should be decreased. Since these longitudinal modes have a different phase they cause interference each other, and they are averaged temporally.

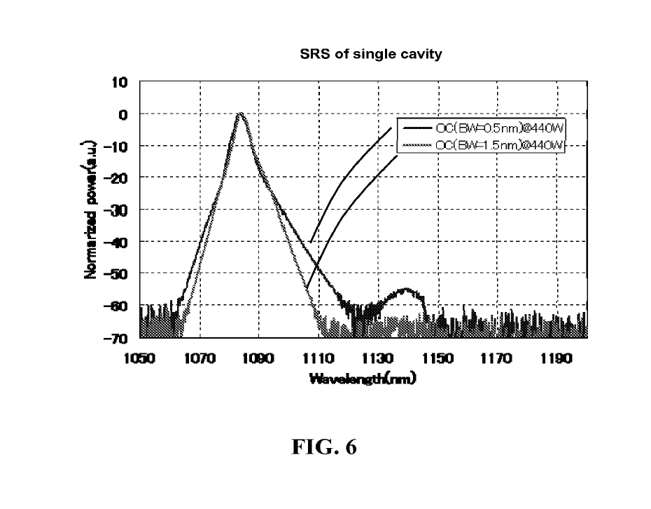

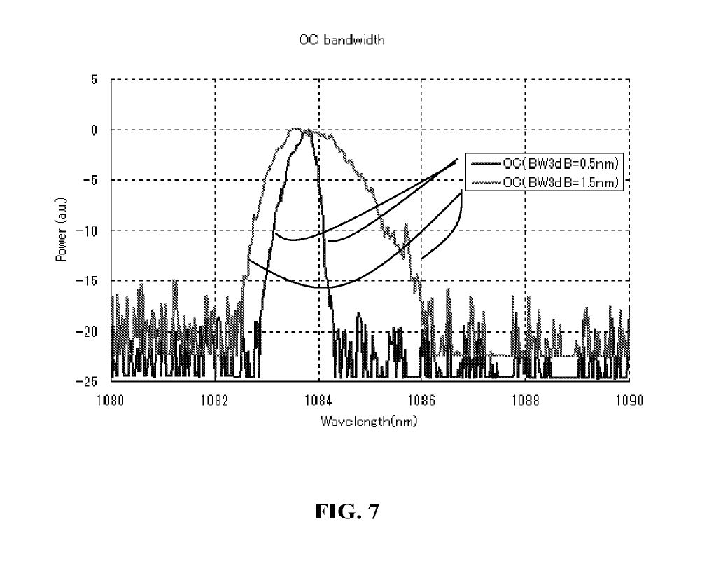

Referring now to FIG. 6, the results of a 440 W output power laser on a single cavity laser having an OC of 0.5 nm and 1.5 nm. The results show SRS of a cavity using 1.5 nm bandwidth OC is lower than that of 0.5 nm bandwidth OC. Referring now to FIG. 7, the loss profile of two OCs are shown for 0.5 nm and 1.5 nm.

A lasing system incorporating the single cavity according to embodiments of the present invention can be used in a variety of applications, including telecommunications applications and high-power military and industrial fiber optic applications. In specific embodiments, the single cavity laser can be used in industrial machining applications, and the output fiber of the single cavity laser can be coupled to a suitable element such as a beam expander to focus the output of the laser on an object or workpiece. The beam expander can be a cylindrical, conical or multi-step cylindrical conical shaped piece of silica glass that lacks a core. The beam expander may also include an output facet, which may be flat or lensed as desired. The output facet may also be coated with an anti-reflective coating to prevent or reduce back-reflections of the emission thereby preventing possible damage to the fiber laser source. Such a device can be used in a variety of applications such as welding, cutting, brazing or drilling a material.

The single cavity according to one or more embodiments of the present could also be incorporated for use in a fiber laser to seed a downstream amplifier assembly.

Reference throughout this specification to “one embodiment,” “certain embodiments,” “one or more embodiments” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention. Furthermore, the particular features, structures, materials, or characteristics may be combined in any suitable manner in one or more embodiments.

Although the invention herein has been described with reference to particular embodiments, it is to be understood that these embodiments are merely illustrative of the principles and applications of the present invention. It will be apparent to those skilled in the art that various modifications and variations can be made to the method and apparatus of the present invention without departing from the spirit and scope of the invention. Thus, it is intended that the present invention include modifications and variations that are within the scope of the appended claims and their equivalents.

1. A cavity for use in a high power fiber laser system, comprising:
a reflective grating;
a gain fiber;
an output coupler, the output coupler having a bandwidth in the range of 1 nm to 2 nm; and
an output fiber connected to the single cavity laser that supplies power from the single cavity.

2. The cavity of claim 1, further comprising a pump diode.

3. The cavity of claim 1, wherein the bandwidth of the output coupler is in the range of 1.2 nm to 2 nm.

4. The cavity of claim 1, wherein the bandwidth of the output coupler is in the range of 1.4 to 2 nm.

5. The cavity of claim 1, wherein the bandwidth of the output coupler is in the range of 1.6 to 2 nm.

6. The cavity of claim 1, wherein the high reflective grating and the output coupler comprise Bragg gratings.

7. The cavity of claim 1, wherein the output fiber is a multimode fiber.

8. The cavity of claim 1, further comprising a pump source to introduce pump light into the gain fiber, the pump source comprising a plurality of pump diodes connected to the single cavity through a pump combiner.

9. The cavity of claim 8, wherein the wavelengths of the pump diodes are in the range of 900 nm to 990 nm.

10. The cavity of claim 8, wherein the number of longitudinal modes in the laser cavity is increased compared to a system that uses an output coupler having a lower bandwidth.

11. The cavity of claim 10, wherein nonlinear effects caused by Stimulated Raman scattering are reduced compared to a single cavity laser that uses an output coupler having a lower bandwidth.

12. The cavity of claim 1, wherein the slope efficiency of the cavity is in the range of 65% to 70%.

13. The cavity of claim 1, wherein the gain fiber comprises a rare earth doped fiber.

14. The cavity of claim 1, wherein the gain fiber has a length of 25 meters or greater.

15. The cavity of claim 1, wherein the gain fiber has a mode field diameter of less than 12 microns.

16. The cavity of claim 8, wherein the pump source provides a power such that the output power of the cavity exceeds 250 Watts.

17. The cavity of claim 1, wherein the pump source has a mean pump wavelength in the range of 900 to 1000 nm.

18. A fiber laser system comprising the single cavity laser of claim 1 and a downstream amplifier seeded by the single cavity.

19. A device for welding, cutting, brazing or drilling a material comprising the single cavity laser of claim 1.

20. A method of reducing Stimulated Raman Scattering (SRS) in of a high power single cavity fiber laser having an output power exceeding 250 Watts comprising optically coupling a fiber amplifier to an output coupler having a bandwidth in the range of 1 nm to 2 nm such that the number of longitudinal modes in the laser cavity are increased to reduce the SRS of laser compared to a single cavity fiber laser having a lower bandwidth.

21. A method of treating an object, comprising:
operating a single cavity laser having a high reflective grating, a gain fiber, an output coupler having a bandwidth in the range of 1 nm to 2 nm and an output fiber connected to the single cavity laser to supply at least 250 Watts of power from the single cavity laser; and
applying the at least 250 Watts of power from the single cavity laser to the object.

22. The method of claim 21, wherein the object is cut, welded, brazed, and/or drilled by the single cavity laser.
